(19) United States
(12) Patent Application Publication
(10) Pub. No.: US 2007/0210121 A1
(43) Pub. Date: Sep. 13, 2007

(54) Discharger for a flowable medium

(76) Inventors: Peter Stadelhofer, Singen (DE); Juergen Greiner-Perth, Gottmadingen (DE); Miro Cater, Daytona Beach, FL (US)

Correspondence Address: FLYNN THIEL BOUTELL & TANIS, P.C., 2026 RAMBLING ROAD, KALAMAZOO, MI, 49008-1631, US

(21) Appl. No.: 11/716,983

(22) Filed: Mar. 12, 2007

(30) Foreign Application Priority Data
Mar. 13, 2006 (DE) 10 2006 012898.2

(51) Int. Cl. B67D 5/40

(52) U.S. Cl. 222/383.1

(57) ABSTRACT

1. Discharger.

2.1. The invention relates to a discharger for a flowable medium, comprising a discharge opening (112) on the one hand, and a medium container or a fastening device (114) for a medium container on the other hand, which are disposed at opposite ends of the discharger in mutual alignment along a principal direction of extent (102) of the discharger, and a pumping device (120) having a pumping chamber closed off on one side by a piston (124), the piston (124) being configured such that it is longitudinally movable along a pumping direction for the generation of a discharge pressure and the pumping direction forming approximately a right angle with the principal direction of extent (102).

2.2 According to the invention, the piston (124) is operatively connected to an actuating device (130) which can be manually pressed in in the pumping direction and which, in a delivery state of the discharger, is held by a securing element (150) in a pressed-in state in which the pumping chamber has a small volume. 2.3 The discharger according to the invention allows, in particular, an advantageous handling in connection with the assembly.

### FIELD OF APPLICATION AND PRIOR ART

The invention relates to a discharger for a flowable medium, in particular for applying the medium into an eye or a nose, comprising a discharge opening on the one hand, and a medium container or a fastening device for a medium container on the other hand, which are disposed at opposite ends of the discharger in mutual alignment along a principal direction of extent of the discharger, and a pumping device having a pumping chamber closed off on one side by a piston, the piston being configured such that it is longitudinally movable along a pumping direction for the generation of a discharge pressure and the pumping direction forming approximately a right angle with the principal direction of extent.

Such dischargers are known from the prior art. They are used, in particular, for cosmetics and medicines. They are usually actuated by means of an actuating device, which is configured for actuation transversely to the principal direction of extent.

It is regarded as a drawback with known dischargers that, because of the actuating device, which is normally provided laterally, they are generally not rotationally symmetric in shape, which constitutes a problem in mechanical handling, particularly with respect to the filling operation.

### Problem and Solution

The object of the invention consists in improving dischargers known from the prior art, particularly with regard to the ease of use.

This object is achieved by a discharger of the generic type in which the piston is operatively connected to an actuating device which can be manually pressed in in the pumping direction and which, in a delivery state of the discharger, is held by a securing element in a pressed-in state in which, in particular, the pumping chamber has a small volume.

The pumping device is actuated by means of the actuating device, the actuating direction of which corresponds to the pumping direction. For this purpose, the actuating device can also be constructed in one piece with the piston. The principal direction of extent runs along a principal axis of the generally elongate discharger. During use, the discharger is held by the user such that the principal direction of extent points approximately in the direction of the eye or some other body part to which or into which the medium is due to be applied. The pumping device, which is disposed transversely in the discharger, and the actuating direction, which is movable in the pumping direction, serve to ensure that the user does not accidentally press the discharger against the open eye or the body part concerned when applying the force necessary to actuate the discharger. Since the pumping direction does not run parallel to a medium duct from the medium container to the pumping chamber or to a medium duct from the pumping chamber to the discharge opening, it is possible on the piston side to seal the pumping chamber against the principal direction of extent with less effort.

For simple actuation, the actuating device preferably has a restoring spring, which acts upon the actuating device with an outward-acting force. This can also be realized by a piston spring of the piston connected to the actuating device. The securing element holds the actuating device counter to the force of a restoring spring in a pressed-in state. It is expedient, in particular, as a transport and/or originality protection. Preferably, prior to removal of the securing element, a pumping process is prevented by the fact that the piston stroke limited by the securing element blocks an inlet valve or an inlet duct in the pumping chamber. Advantageously, medium-carrying connecting ducts between the medium container and the outlet opening are thus sealed off. A small volume within the meaning of the invention is obtained when the pumping chamber volume is less than the maximum volume of the pumping chamber. Preferably, this small volume is so low that, once the securing element is removed, an underpressure is generated in the pumping chamber, by which medium is sucked out of the medium container into the pumping chamber, so that the medium is discharged upon the very first actuating pressure following removal of the securing element, without the need for further activation steps.

The securing element is advantageous, in particular, with regard to the external shape of the discharger. In the state in which it is secured with the securing element, the actuating device, or a, for example, knob-shaped portion, does not jut or juts to a lesser extent radially away from the housing compared with the unsecured state. This results in a smaller size of the discharger in the secured delivery state and therefore allows more economical packaging. Furthermore, the mechanical handling, in particular in the filling of the discharger or in the fastening of the medium container to the discharger, is simplified if regard does not have to be given by the handling machines to the orientation of the discharge handle.

In one refinement of the invention, the discharger, in the delivery state, has a rotationally symmetric or almost rotationally symmetric external shape. This allows a particularly advantageous handling by filling machines. In particular, grippers with gripping devices can be used, the gripping devices of which have a round clearance for grabbing of the dischargers. Such a rotationally symmetric external shape is advantageous also in the conveyance of the discharger, for example on belts, since there is no need to fear that the discharger might get caught and jammed on its actuating devices. With respect to the packaging, the rotationally symmetric configuration allows a particularly efficient use of space.

In one refinement of the invention, the securing element is a flexible securing band, which, at least in the region of the actuating device, surrounds the discharger.

Such a securing band is, in particular, simple and cost-effective. For manual removal, it can have, for example, a perforated parting line or a tear tab and can also be removable by means of scissors. It is preferably configured as a paper band or is made from an only slightly elastic plastic. It is advantageous if the housing wall of the discharger has a greater extent in the regions adjacent to the actuating device than in the region of the actuating device, so that the securing band cannot slide off the discharger without being tampered with.

In one refinement of the invention, the securing element is a detachable securing portion of a housing of the discharger. This securing portion is removed in the course of the activation of the discharger. The fastening to the housing serves effectively to prevent the securing portion from inadvertently coming off in the handling. In the case of securing portions which are integrally connected to the housing, it is further advantageous that these are very cheap to produce, since no additional components are necessary. Preferably, the securing portion, after being detached for the first time, cannot be fitted back into its initial state. However, embodiments are also conceivable and, according to the purpose of use, expedient, in which the securing portion can be non-destructively detached and reused.

Securing portions are preferred which are integrally connected to the housing and are connected by destructible connecting portions to other portions of the housing. A securing portion which is integrated in the housing is expedient in particular by virtue of the fact that it is restorable only with great effort and can hence ensure, in particular, the originality of the discharger. It is particularly expedient if the securing portion is connected to the rest of the housing with a plastics film or thin plastics webs, the plastics film or the plastic webs being dimensioned such that the force of the restoring spring is not sufficient to sever it/them without manual assistance. The advantage of the plastics film is that the housing can be kept dust-tight. The removal of the securing portion can be realized, for example, by pressing in the securing portion, this offering the advantage that the actuating device is also thereby pressed in up to its limit position with the smallest pumping chamber volume, so that, following subsequent release, both the securing portion is removed and the pumping chamber is filled with the medium so as to be ready for use.

Preferably, the securing portion is of substantially circular configuration. Such a securing portion can be rotated about its center axis for removal purposes, so that the securing webs break or the plastics film serving as a securing film tears.

For this purpose, the securing portion preferably has a handling means, by which it can be held for the purpose of relative movement relative to the discharger. The handling means can here be configured such that a user, preferably without a tool or at least without a specially adapted tool, can induce a relative movement of the securing portion relative to the housing. Such a handling means can be a molded-on web, which is gripped with two fingers and is then pressurized or twisted.

However, preference is for a handling means which is a non-round indentation, preferably a longitudinally extending groove. A indentation offers the advantage that it does not adversely enlarge the external shape. This is a considerable advantage, particularly in the case of rotationally symmetric external shapes. A longitudinally extending groove can serve, in particular, for the introduction of a coin, by means of which the securing portion can then be twisted.

In one refinement of the invention, the actuating device, in the delivery state, is remote from its pressed-in limit position. This allows the securing element to be detached by being pressed in. The remoteness from the limit position should accordingly be sufficiently large to induce a detachment of the securing element, in particular a breaking-off of the securing element, when the securing element and the actuating device are pressed in up to the limit position. A lesser deflection can also suffice, provided that this is sufficiently large to weaken the securing element or its fastening in such a way that it is subsequently detached under the pressure of a spring-loading of the actuating device.

### BRIEF DESCRIPTION OF THE DRAWINGS

Further advantages and features of the invention emerge from the claims and the following description of two preferred illustrative embodiments of the invention, which are represented with reference to the drawings in which:

FIGS. 1a and 1b show a first embodiment of a discharger according to the invention in a sectioned representation and a perspective view, and

FIGS. 2a to 2d show a second embodiment of a discharger according to the invention in an unsectioned side view, a sectioned side view, a detailed view of a securing portion and a perspective view.

### DETAILED DESCRIPTION OF THE ILLUSTRATIVE EMBODIMENTS

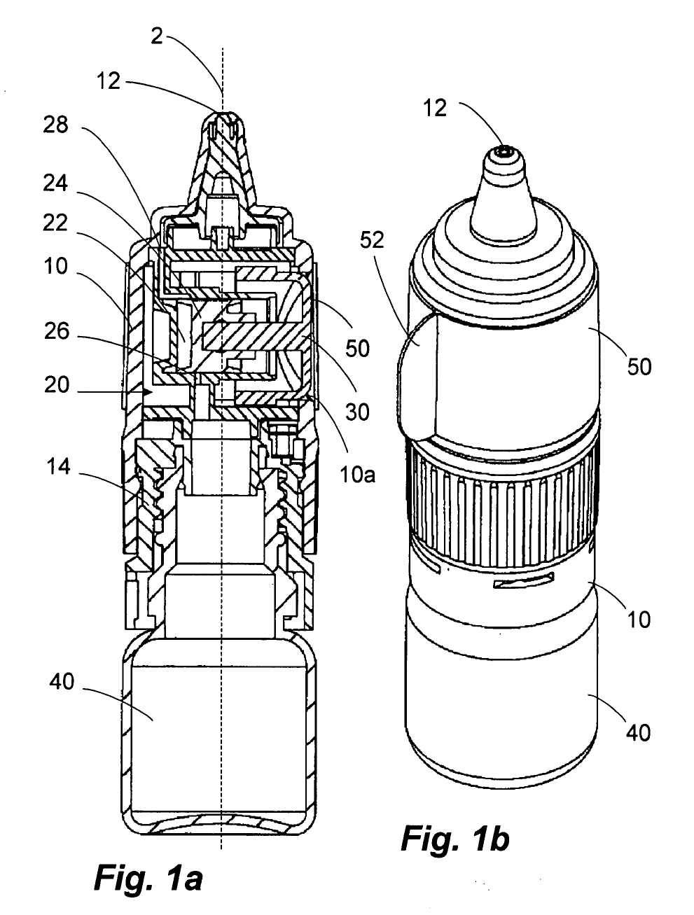

The first embodiment, which is represented in FIGS. 1a and 1b, has a housing 10, which extends substantially in a principal direction of extent 2. The housing 10 is configured broadly rotationally symmetrically in relation to this principal direction of extent. At an upper end there is provided a discharge opening 12, and at a lower end a fastening device 14 into which a medium container 40 is screwed.

In the housing 10 there are contained all basic functional elements which are necessary for a discharge process. These comprise a pumping device 20 having a pumping chamber 22 and a piston 24. The pumping chamber is connected by a first feed line 26 to the medium container 40 and by a second feed line 28 to the discharge opening 12. The piston 24 is configured for a piston movement which is orientated transversely to the principal axis of extent 2.

The piston 24 is fixedly connected to an actuating device 30, which, in an operating state (not represented), juts through a recess 10a of the housing 10 and allows, transversely to the principal axis of extent 2, an actuation of the pumping device 20 counter to a spring force of a restoring spring (not represented).

The representation of FIGS. 1a and 1b shows the delivery state of the portrayed discharger. This is characterized by a securing band 50, which, in the region of the actuating device 30, is placed around the discharger. The securing band 50 is configured as a closed band. For this purpose, its two ends are joined together, for example stuck together, and form a tab 52. The securing band is dimensioned such that it has no play or only slight play. It is made sufficiently strong to hold the actuating device, which is forced radially outward by the spring force of the restoring spring, in a pressed-in position. Hence, in the delivery state, the rotationally symmetric discharger is broadly rotationally symmetric even in the region of the actuating device 30. Only the flexible tab 52 juts radially outward.

The represented state is ideal with regard to the handling of the discharger prior to sale to the end customer. The external dimensions are small, so that small pack sizes are usable. The broadly full rotational symmetry allows a mechanical handling which does not need to pay any regard to the orientation relative to the rotational position about the principal direction of extent 2. This is advantageous, in particular, when connecting the medium container 40 to the upper part of the discharger. A further advantage lies in the fact that the secured state is, at the same time, a state with low pumping chamber volume. As soon as the actuating device 30 and the piston 24 are forced radially outward for the first time, the pumping chamber 22 consequently fills with medium, so that an idle stroke to be executed by the user is unnecessary.

For the activation of the discharger, the securing band 50 is removed by the user. In the represented discharger, this can be done by simply sliding off the securing band 50 in the direction of the discharge opening 12. In further, non-represented embodiments, the simple sliding-off is prevented by the fact that the band is disposed in a region of smaller extent relative to adjoining regions, so that a destruction is necessary to the removal. Such a securing band thereby ensures an effective originality protection. The destruction is here preferably realized at a predetermined breaking point, for example a perforation line.

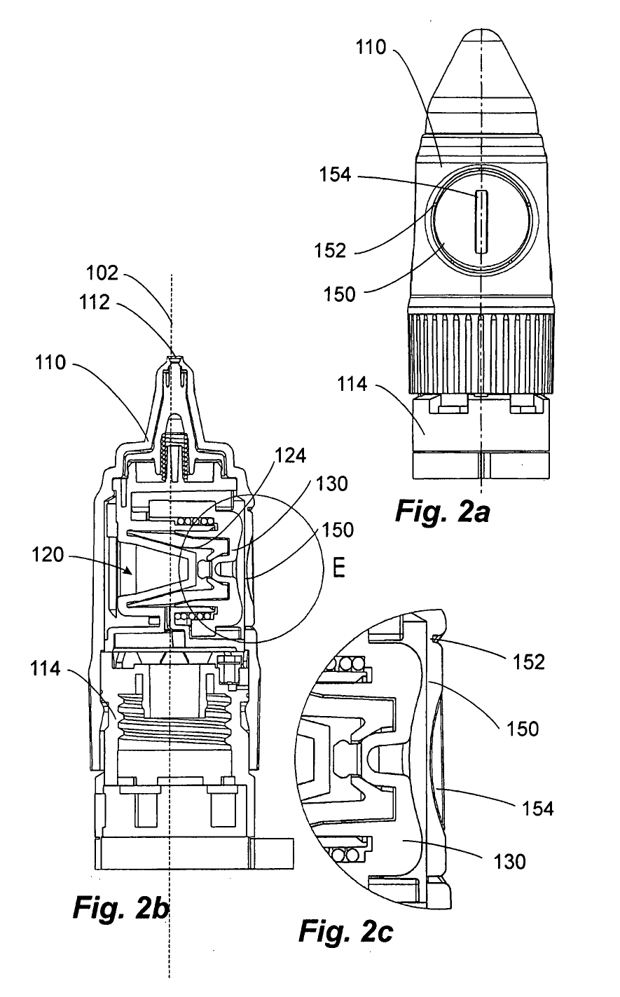

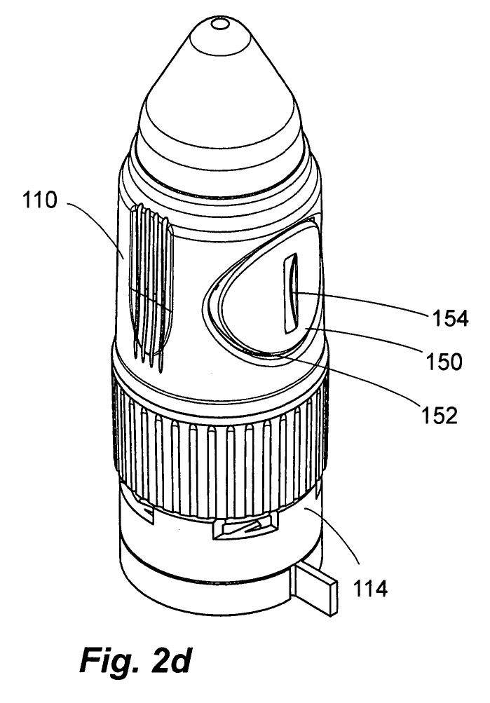

The embodiment of FIGS. 2a to 2d is constructed similarly to the first embodiment. It likewise has a housing 110, which is orientated in a principal direction of extent 102 and at the opposite ends of which there are provided a discharge opening 112 and a fastening device 114 for a medium container. In addition, this second embodiment likewise comprises a pumping device 120, which, though not constructed identically with the pumping device 20 of the first embodiment, still conforms to the latter in terms of the actuating direction transversely to a principal axis of extent 102. The pumping device likewise has a piston 124, which is fixedly connected to an actuating device 130 which can be operated transversely to the principal direction of extent.

The embodiment of FIGS. 2a to 2d is also represented in a delivery state. In this delivery state, the actuating device 130 is in a pressed-in state. It is here pressed in yet more deeply than the actuating device 30 of the first embodiment. The pressed-in state is secured by a securing portion 150. This is configured in one piece with the housing 110 and is connected thereto by predetermined breaking webs 152. The securing portion has an approximately round shape and boasts on its outward-pointing side a slot-like recess 154.

Alternatively, the securing portion 150 can be connected to the housing 110 by a film hinge in the form of a plastics film 152, the film thickness being chosen such that a manual severance is enabled with or without a manually operated cutting tool.

The advantages of this second embodiment of FIGS. 2a to 2d broadly correspond to the advantages of the first embodiment. Added to this is the fact that the integral configuration of the securing element 150 with the housing 110 allows a particularly simple and cost-effective manufacture, in which no additional components are necessary. Furthermore, such a securing element 150 is particularly reliable and cannot be inadvertently detached even if the discharger is roughly handled.

The activation is realized, as in the first embodiment, by removal of the securing portion. This removal is achieved by a breaking of the predetermined breaking webs 152, this being particularly easily achieved, in the represented second embodiment, through the introduction of a suitable object, in particular a coin, into the slot 154 and a subsequent twisting of the securing portion 150. Alternatively, the securing portion can be pressed in until the predetermined breaking webs 152 break. Analogously, the plastics film can be severed, in which case, instead of a coin, a small knife or a similar sharp-edged object may also be used as a suitable manually operated tool.

1. Discharger for a flowable medium, comprising
a discharge opening (12; 112) on the one hand, and a medium container (40) or a fastening device (14; 114) for a medium container (40) on the other hand, which are disposed at opposite ends of the discharger in mutual alignment along a principal direction of extent (2; 102) of the discharger, and
a pumping device (20; 120) having a pumping chamber (22) closed off on one side by a piston (24; 124), the piston (24; 124) being configured such that it is longitudinally movable along a pumping direction for the generation of a discharge pressure,
the pumping direction forming approximately a right angle with the principal direction of extent (2; 102), characterized in that the piston (24; 124) is operatively connected to an actuating device (30; 130) which can be manually pressed in in the pumping direction and which, in a delivery state of the discharger, is held by a securing element (50; 150) in a pressed-in state in which, in particular, the pumping chamber (22) has a small volume.

2. Discharger according to claim 1, characterized in that the discharger, in the delivery state, has a rotationally symmetric or almost rotationally symmetric external shape.

3. Discharger according to claim 1, characterized in that the securing element (50) is a flexible securing band (50), which, at least in the region of the actuating device (30), surrounds the discharger.

4. Discharger according to claim 1, characterized in that the securing element (150) is a detachable securing portion (150) of a housing (110) of the discharger.

5. Discharger according to claim 4, characterized in that the securing portion (150) is configured in one piece with the housing (110) and is connected by destructible connecting portions (152) to other portions of the housing (110).

6. Discharger according to claim 4, characterized in that the securing portion (150) is of substantially circular configuration.

7. Discharger according to claim 4, characterized in that the securing portion (150) has a handling means (154), by which it can be held for the purpose of relative movement relative to the discharger.

8. Discharger according to claim 7, characterized in that the handling means (154) is a non-round indentation (154), preferably a longitudinally extending groove (154).

9. Discharger according to claim 1, characterized in that the actuating device (130), in the delivery state, is remote from its pressed-in limit position.
